(19) United States
(12) Patent Application Publication
(10) Pub. No.: US 2007/0011492 A1
(43) Pub. Date: Jan. 11, 2007

(54) Generation of trace data

(75) Inventor: Andrew Brookfield Swaine, Cambridge (GB)

Correspondence Address: NIXON & VANDERHYE, PC, 901 NORTH GLEBE ROAD, 11TH FLOOR, ARLINGTON, VA, 22203, US

(73) Assignee: ARM Limited, Cambridge (GB)

(21) Appl. No.: 11/173,155

(22) Filed: Jul. 5, 2005

(51) Int. Cl. G06F 11/00

(52) U.S. Cl. 714/35

(57) ABSTRACT

An apparatus and method for processing data is disclosed. The apparatus comprises a data processing circuit operable over a sequence of processing cycles to perform data processing operations in response to program instructions and a tracing circuit configurable to perform a selected one of a number of tracing activities in which corresponding trace data is generated indicative of operation of the data processing circuit in response to the program instructions. The tracing circuit is operable to be responsive to trace instructions inserted into the program instructions to control execution of the selected one of a number of tracing activities in order to generate the trace data, each trace instruction being operable to control execution of each of a number of the tracing activities. Hence, the tracing circuit is operable to perform a number of tracing activities and is configurable to perform a selected one of those tracing activities. Trace instructions are inserted into the program instructions of the software code to be analysed. The occurrence of the trace instructions in the program instructions controls the execution of the selected tracing activity. Hence, each occurrence of a trace instruction can control the tracing activity. By controlling the execution of the tracing activity using trace instructions rather than by using trigger logic, the number of conditions under which trace data is generated can be greatly increased. Because each tracing instruction controls a number of tracing activities the number of different tracing instructions required to be provided can be limited. Hence, it will be appreciated that the effect of any particular trace instruction will vary depending on the configuration of the tracing circuit and the tracing activity which has been selected. Accordingly, the same trace instruction can have a different effect depending on the arrangement of the trace circuit. Such an arrangement enables a wide range of tracing activities to be performed and a variety of trace data to be generated whilst still being controlled by a small number of trace instructions.

### BACKGROUND OF THE INVENTION

1. Field of the Invention

The present invention relates to the generation of trace data within a data processing apparatus.

2. Background of the Invention

Tracing the activity of a data processing system whereby a stream of trace data is generated including data representing the step by step activity within the system is a highly useful tool in system development. However, with the general move towards more deeply embedded processor cores, it becomes more difficult to track the architectural state of the processor core (such as the contents of the registers, the values stored at particular memory locations or the status of various buses, paths, lines, flags or modules within the processor core or to which the processor core is coupled) via externally accessible pins. Accordingly, as well as off-chip tracing mechanisms for capturing and analysing trace data, increased amounts of tracing functionality are being placed on-chip. An example of such on-chip tracing mechanisms is the Embedded Trace Macrocell (ETM) provided by ARM Limited, Cambridge, England, in association with various of their ARM processors.

Such tracing mechanisms produce a real time stream of trace data representing the activities of the data processing system that are desired to be traced. This stream of trace data can then subsequently be used to facilitate debugging of sequences of processing instructions included in software code being executed by the data processing apparatus.

Typically, when the trace is first triggered, the values of all items of architectural state which may need to be reconstructed are traced as trace data.

Typically, the stream of trace data that is generated by the ETM is buffered prior to output for subsequent analysis. Such a trace buffer is able to store finite amount of information and requires a dedicated data bus which has a finite bandwidth over which the trace data to be buffered can be received. The trace buffer is generally arranged to store information in a wrap around manner, i.e. once the trace buffer is full, new data is typically arranged to over write the oldest data stored therein. It has been found that the bandwidth of the dedicated data bus can limit the rate of which information can be stored in the trace buffer. Typically, a trace analysing tool is provided which then receives the trace data from the trace buffer when desired; e.g. once the trace has completed. The trace analysing tool can then reconstruct critical components of the architectural state of the processor core using the stream of trace data stored in the trace buffer. The trace analysing tool can therefore reconstruct the behaviour of the processor core based on the trace data.

As data processing systems increase in power and complexity, it is clear that the amount of architectural state and its rate of change will increase. Hence, in order to reliably reconstruct the architectural state it will be appreciated that there is potentially a very large volume of trace data which needs to be traced.

However, there is a problem in that there is a finite bandwidth over which the trace data to be buffered is received and the trace buffer has a finite size. Accordingly, the volume of trace data that can be buffered and, hence, the amount of architectural state that can be reconstructed is limited.

One possible solution to reduce the amount of trace data which is generated is to filter the trace data in some way. Filtering is generally possible because during debug it is often desired to only analyse a particular subset of activities being performed by the data processing apparatus or a particular subset of the code being executed by the data processing apparatus. It is known to provide trigger logic which generates a signal when trace data is to be generated. The trigger logic typically comprises a number of registers together with associated comparators. Each register is programmed to store a particular condition of interest under which trace data is to be generated. The associated hardware comparators access the registers and receive architectural state. When a match occurs, the comparators output a signal which causes trace to be initiated. Typically, each register contains an instruction address relating to particular sections of code which, when executed, will cause trace data to be generated.

However, a problem with this approach is that the number of comparators, registers and associated logic that can be provided within the trigger logic is typically very limited. Hence, the number of different conditions which can cause trace to be generated is also very limited. For example, in known arrangements, four sets of comparators, registers and associated logic are provided which means that four sets of conditions could be programmed under which trace data is generated. Accordingly, if sections of code were to analysed, it would be possible at any one time to set up to four address ranges, the occurrence of which would result in trace data being generated.

Hence, when analysing any reasonably sized piece of software code, a great deal of time and effort is expended in determining the conditions under which trace is to be initiated, and programming the registers for a subset of those conditions of interest. The software code to be analysed can then be executed, the data trace for those particular conditions generated and then analysed. It will be appreciated that in order to fully analyse a piece of software code for all the conditions of interest, many different register configurations and software code executions will be required since only a limited number conditions can be defined under which trace data is generated.

Whilst it would be possible to increase the number of registers and comparators in the trigger logic, it will be appreciated that such an increase will cause significant increase in the silicon area used dedicated to tracing, which is undesirable. Also, whilst it would be possible to set broad conditions under which trace data is generated, this would result in high volumes of trace data being generated.

Accordingly, it is desired to provide an improved technique for generating trace data.

### SUMMARY OF THE INVENTION

According to a first aspect of the present invention there is provided an apparatus for processing data, the apparatus comprising: a data processing circuit operable over a sequence of processing cycles to perform data processing operations in response to program instructions; and a tracing circuit configurable to perform a selected one of a number of tracing activities in which corresponding trace data is generated indicative of operation of the data processing circuit in response to the program instructions, the tracing circuit being operable to be responsive to trace instructions inserted into the program instructions to control execution of the selected one of a number of tracing activities in order to generate the trace data, each trace instruction being operable to control execution of each of a number of the tracing activities.

The tracing circuit is operable to perform a number of tracing activities and is configurable to perform a selected one of those tracing activities. Trace instructions are inserted into the program instructions of the software code to be analysed. The occurrence of the trace instructions in the program instructions controls the execution of the selected tracing activity. Hence, each occurrence of a trace instruction can control the tracing activity. By controlling the execution of the tracing activity using trace instructions rather than by using trigger logic, the number of conditions under which trace data can be generated is greatly increased. Hence, instead of being limited to typically only four sets of conditions which are programmed into trigger logic, trace data can be generated for a greatly increased set of conditions.

Because each tracing instruction controls a number of tracing activities, the number of different tracing instructions required to be provided can be reduced to a minimum. It will be appreciated that the effect of any particular trace instruction will vary depending on the configuration of the tracing circuit and the tracing activity which has been selected. Accordingly, the same trace instruction can have a different effect depending on the arrangement of the trace circuit. Such an arrangement enables a wide range of tracing activities to be performed and a variety of trace data to be generated whilst still being controlled by a small number of trace instructions.

Hence, it will be appreciated that this arrangement enables trace data to be generated under a wide range of conditions without the need for trigger logic incorporating a proportionate number of registers and associated comparators to be provided.

In one embodiment, the trace instructions include a trace set instruction operable to cause the tracing circuit to generate trace data by causing the selected one of a number of tracing activities to be initiated.

Accordingly, once the tracing circuit has been configured to select the tracing activity, the provision of a simple trace set instruction can cause the tracing circuit to generate trace data. It will be appreciated that this provides a simple and convenient mechanism for initiating trace.

In one embodiment, the trace instructions include a trace clear instruction operable to cause the tracing circuit to cease generating trace data by causing the selected one of a number of tracing activities to be terminated.

Providing a trace clear instruction also provides a convenient mechanism for stopping the selected trace activity, thereby causing the generation of trace data to be terminated.

Hence, it will be appreciated that the provision of trace set instructions and trace clear instructions in the program code enables tracing to be activated and deactivated as required.

In one embodiment, the trace instructions include a trace toggle instruction operable to cause the tracing circuit to generate trace data for a number of processing cycles by causing the selected one of a number of tracing activities to be initiated in a first processing cycle and then terminated in a subsequent processing cycle.

Providing a trace toggle instruction enables trace data to be generated for a predetermined number of sequential processing cycles. Hence, the effect of the trace toggle instruction is comparable to a trace set instruction being firstly issued in a first processing cycle and then a trace clear instruction being issued in a subsequent processing cycle. Accordingly, trace data can be generated for just a predetermined number of processing cycles. It will be appreciated that this instruction has particular utility when counting profiling events.

In one embodiment, the trace toggle instruction is operable to cause the tracing circuit to generate trace data for a single processing cycle by causing the selected one of a number of tracing activities to be initiated in the first processing cycle and then terminated in an immediately following processing cycle.

In one embodiment, each trace instruction has the effect on the operation of the data processing circuit of an architectural no-operation.

Accordingly, although trace instructions are inserted into the sequence of program instructions, their effect is negligible since they are effectively transparent to the processing activities of the data processing circuit. Hence, the presence of the trace instructions has a negligible impact on the normal operation of the data processing circuit which behaves in virtually unaffected manner.

In one embodiment, each trace instruction is executable in a single processing cycle.

Hence, as mentioned above, the execution time of each trace instruction is low and therefore the impact on the performance and throughput of the data processing circuit is minimised by the inclusion of such trace instructions.

In one embodiment, the number of tracing activities include instruction tracing in which trace data comprising information representative of program instructions being processed by the data processing circuit is generated.

Accordingly, one of the selected tracing activities is to perform instruction tracing whereby the tracing circuit generates trace data indicative of the program instructions which are being executed by the data processing circuit.

In one embodiment, the number of tracing activities include data tracing in which trace data comprising information representative of data values being processed by the data processing circuit in response to the program instructions is generated.

Accordingly, the tracing circuit is configurable to perform data tracing whereby trace data which indicates the data values being accessed by the data processing circuit when executing the program instructions are generated.

In one embodiment, the tracing circuit is further configurable to cause a triggering event in which a triggering signal is generated which causes a predetermined action to occur, the tracing circuit being further operable to be responsive to trace instructions inserted into the program instructions to control execution of the triggering event.

Accordingly, the tracing circuit can be arranged to cause a triggering event in response to trace instructions inserted into the program instructions. It will be appreciated that such a triggering event can be used for a variety of purposes.

In one embodiment, the apparatus further comprises a trace buffer operable to store trace data and wherein the predetermined action comprises signalling the trace buffer to cease the storage of trace data after a predetermined period.

Accordingly, when a triggering event occurs the trace buffer is prevented from storing any further trace data which may be generated subsequently by the tracing circuit. This ensures that the amount of data stored in the trace buffer can be limited to only that trace data which it is desired to be traced. The predetermined period may be immediately, or some time period, or some amount of further trace data thereafter.

In one embodiment, the predetermined action comprises changing a counter value to indicate the occurrence of the triggering event.

It will be appreciated that changing counter values is a convenient way to count profiling events.

In one embodiment, the predetermined action comprises entering a debug state to enable operation of the data processing circuit to be determined.

By entering a debug state it will be appreciated that the status and operation of the data processing circuit can readily be determined.

In one embodiment, the predetermined action comprises passing a signal external to the tracing circuit to enable operation of the data processing circuit to be determined.

In one embodiment, the tracing circuit is configurable to perform a selected one of a plurality of tracing activities and each tracing instruction is operable to control execution of each of the plurality of tracing activities.

Hence, it will be appreciated that each trace instruction is operable to control the execution of every tracing activity supported by the trace circuit.

In one embodiment, each trace instruction comprises an instruction identifier, the tracing circuit is configurable to perform a plurality of tracing activities, and each trace instruction having the same identifier is operable to control execution of one of said plurality of tracing activities.

In one embodiment, each trace instruction comprises an instruction identifier, the tracing circuit is configurable to perform a plurality of tracing activities, and each tracing activity is responsive to trace instructions having a predetermined instruction identifier.

Accordingly, the tracing circuit may be configured to perform any of a number of tracing activities. Each trace instruction has an instruction identifier. Each tracing activity can be arranged to be responsive to trace instructions which only have a predetermined instruction identifier. Hence, the execution of that trace activity can be controlled only by instructions having the predetermined instruction identifier. Accordingly, the trace circuit can ignore those trace instructions which have do not have instruction identifiers associated with the selected trace activity. It will be appreciated that this approach provides for enhanced flexibility since particular trace instructions within the software code may be simply ignored, whilst other trace instructions will control the execution of different trace activities based on the configuration of the trace circuit and the presence of particular instruction identifiers.

According to a second aspect of the present invention there is provided a method of tracing data in a data processing circuit operable over a sequence of processing cycles to perform data processing operations in response to program instructions, the method comprising the steps of: configuring a tracing circuit to perform a selected one of a number of tracing activities in which corresponding trace data is generated indicative of operation of the data processing circuit in response to the program instructions; controlling execution of the selected one of a number of tracing activities using trace instructions inserted into the program instructions in order to generate the trace data, each trace instruction being operable to control execution of each of a number of the tracing activities.

According to a third aspect of the present invention there is provided a computer program product comprising a trace instruction operable when executed on a data processing apparatus to perform the step of: controlling execution of a selected one of a number of tracing activities in order to generate trace data, said trace instruction being operable to control execution of each of a number of tracing activities.

According to a fourth aspect of the present invention there is provided a method of modifying compiled software to be executed by a processor core, the method comprising the steps of: providing a compiled software code image having at least one predetermined first instruction inserted therein; and generating a modified software code image by substituting at least one of the predetermined first instructions with a predetermined second instruction, wherein at least one of the predetermined first instruction and the predetermined second instruction comprises a trace instruction.

Accordingly, either the first predetermined instruction or the second predetermined instruction may be a trace instruction and one or more first predetermined instruction may be replaced by the second predetermined instruction without needing to recompile the software code image.

### BRIEF DESCRIPTION OF THE DRAWINGS

The present invention will be described further, by way of example only, with reference to preferred embodiments thereof as illustrated in the accompanying drawings, in which:

FIG. 1 is a block diagram of a data processing apparatus according to an embodiment of the present invention;

FIG. 2 is a block diagram illustrating the arrangement of the on-chip trace module of FIG. 1;

FIG. 3 is a block diagram showing the arrangement of the trace resources illustrated in FIG. 2;

FIG. 4 is a block diagram showing the arrangement of the trace activity logic of FIG. 3;

FIG. 5 illustrates schematically the flow of a sequence of program instructions into which trace instructions have been inserted to control tracing activities which generate trace data;

FIGS. 6a to 6c illustrate different traces generated depending on the configuration of the data tracing circuit.

FIG. 7 illustrates schematically the flow of another sequence of program instructions into which trace instructions have been inserted to control tracing activities which generate trace data; and

FIG. 8 illustrates schematically the recompiling of a software code image to incorporate trace instructions.

### DESCRIPTION OF THE PREFERRED EMBODIMENTS

FIG. 1 schematically illustrates a data processing apparatus 2 providing an on-chip trace module 10. An integrated circuit 4 includes a processor core 6, a cache memory 8, an on-chip trace module 10 and an on-chip trace buffer 12. It will be appreciated that whilst this illustrative embodiment shows an on-chip trace module 10 and on-chip trace buffer 12, the trace module 10 and/or trace buffer 12 could instead be provided separately and coupled with the integrated circuit 4 or processor core 6.

The data processing apparatus 2 has architectural state associated therewith. Typically, some architectural state is associated with each instruction the processor core 6 is executing. Other architectural state will relate to the overall operation or status of the processor core or other modules or units to which the processor core 6 or data processing apparatus 2 is coupled. Such architectural state may include the contents of registers, the values stored at particular memory locations or the status of various buses, paths, lines, flags or modules within the data processing apparatus 2 or to which the data processing apparatus 2 is coupled.

A general purpose computer 16 is coupled to the on-chip trace module 10 and to the on-chip trace buffer 12. The general purpose computer 16, operating as a trace analysing tool, and under the control of software being executed thereon, recovers a stream of trace data which is composed of a number of trace elements. These trace elements are then analysed by the trace analysing tool. The trace elements provide information which is used to reconstruct the architectural state of the data processing apparatus 2. By reconstructing the architectural state of the data processing apparatus 2, the step-by-step activity within the data processing apparatus 2 can be determined which is useful when attempting to debug sequences of processing instructions being executed by the data processing apparatus 2.

The general purpose computer 16 may be provided in advance with the sequence of instructions being executed by the processor core 6 which may be referred to when reconstructing the architectural state of the data processing apparatus 2.

The integrated circuit 4 is connected to an external memory 14 which is accessed when a cache miss occurs within the cache memory 8. It is often the case that the processor core 6 may, during operation, need to access more data processing instructions and data than there is actually space for in the external memory 14. For example, the external memory 14 may have a size of 1 MB, whereas the processor core 6 might typically be able to specify 32-bit memory addresses, thereby enabling 4 GB of instructions and data to be specified. Accordingly, all of the instructions and data required by the processor core 6 are stored within external storage 18, for example a hard disk, and then when the processor core 6 is to operate in a particular state of operation, the relevant instructions and data for that state of operation are loaded into the external memory 14. The contents and status of the cache memory 8, the external memory 14 and the external storage 18 are items of architectural state which are often necessary to trace in order to accurately reconstruct the operation of the processor core 6.

Within the processor core 6 there is provided a register bank 20 containing a number of registers for temporarily storing data. An arithmetic and logic unit (ALU) 22 is also provided for performing various arithmetical or logical operations on the contents of the register bank 20. Following an operation by the ALU 22, the result of the operation may be either recirculated into the register bank 20 via the bus 24 and/or stored in the cache 8 over the bus 26. The contents and status of the register bank 20 or the status of the ALU 22 or the internal or external buses are also items of architectural state which are often necessary to trace in order to accurately reconstruct the operation of the processor core 6.

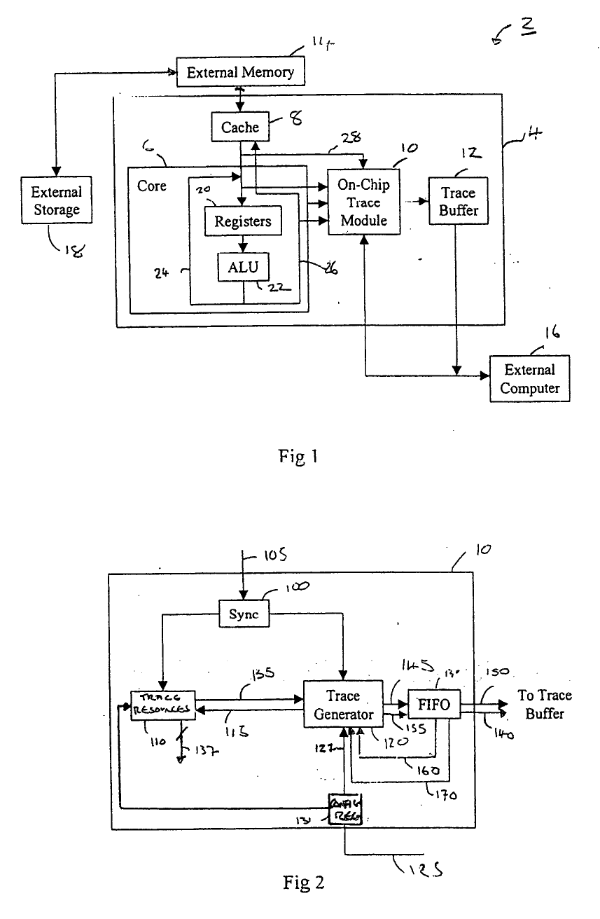

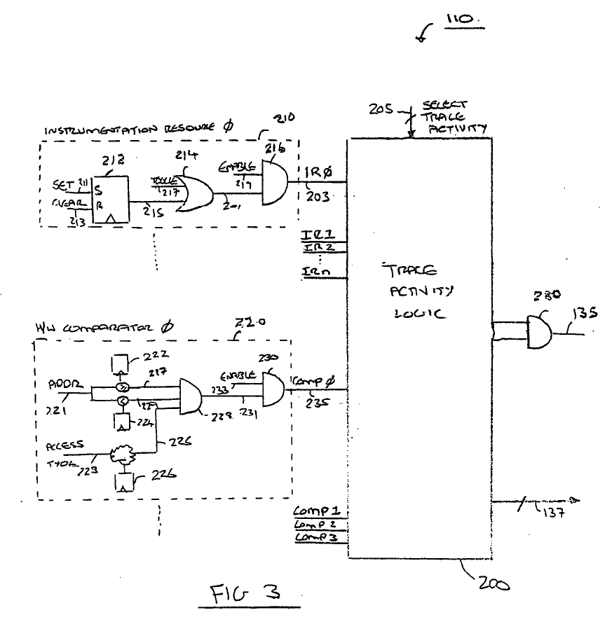

FIG. 2 is a block diagram illustrating in more detail the components provided within the on-chip trace module 10 of FIG. 1. The on-chip trace module 10 is arranged to receive over path 105 data indicative of the processing being performed by the processor core 6. With reference to FIG. 1, this may be received from the buses 24 and 26 connecting the processor core 6, cache 8, and on-chip trace module 10 (such data providing an indication of the architectural state of the data processing apparatus 2 such as, for example, indicating instructions and/or data presented to the processor core 6, and data generated by ALU 22 of the processor core 6), along with additional control-type data received directly from the core over bus 28 (also providing an indication of the architectural state of the data processing apparatus 2 such as, for example, an indication that the instruction address is being indexed, an indication that a certain instruction failed its condition codes for some reason, etc). As will be appreciated by those of ordinary skill, in certain embodiments both types of data could be passed to the trace module 10 over a single bus between the trace module 10 and the processor core 6 (rather than using multiple buses 24, 26, 28 etc.).

The sync logic 100 is arranged to convert the incoming signals into internal versions of the signals more appropriate for use within the on-chip trace module 10. These internal versions are then sent to the trace resources 110 and the trace generation logic 120, although it will be appreciated that the trace resources 110 and the trace generation logic 120 will not necessarily need to receive the same signals. Fundamentally, the trace resources 110 needs to receive data relating to triggerable events, for example instruction addresses, data values, register accesses or the occurrence of some other architectural state or, as will be explained in more detail below, the occurrence of a trace instruction. The trace generation logic 120 needs to receive any data or information that would need to be traced dependent on the enable signals issued by the trace resources 110.

Configuration registers 131 are provided which receives configuration information over the path 125 from the general purpose computer 16, whose contents can be read by the components of the on-chip trace module 10 to control their operation as required. For example, the configuration registers 131 may be programmed to indicate to the trace resources when to generate a trace stream.

Generally, whenever the trace resources 110 detect events which should give rise to the generation of a trace stream, it sends an enable signal over path 135 to the trace generation logic 120 to turn the trace on and off. The trace generation logic 120 reacts accordingly by outputting the necessary trace elements to the FIFO 130 over paths 145 and 155. It will be appreciated that a variety of enable signals may be provided over path 135, to identify the type of signals which should be traced, for example trace only instructions, trace instructions and data, data only, other architectural state information only, etc. Alternatively, or additionally, when the trace resources 110 detects events of interest, it sends a trigger signal over the path 137 which causes a predetermined action to occur either within the on-chip trace module 10, the integrated circuit 4, the data processing apparatus 2 or some other device coupled thereto. For example, the trigger signal may be provided to the trace buffer 12 to prevent any further trace data which may be generated from being stored. Alternatively, the trigger signal may be provided to the trace buffer 12 to allow a further predetermined amount of trace data to be stored (for example a further 1K of data) and only thereafter to prevent any further trace data which may be generated from being stored. The trigger signal may be provided to a counter or number of counters (not shown) the values of which may be adjusted in response to the trigger signal in order to generate profiling information. Also, the trigger signal may cause the data processing apparatus 2 to enter a debug state or be provided to an external device which causes the operation of the data processing apparatus 2 to be suspended, thereby enabling the state of the data processing apparatus 2 to be determined.

Typically, the trace signals or trace elements generated by the trace generation logic 120 are classified as being either high priority or low priority. The classification will preferably be maintained within the trace generation block 120, and may be predefined or user programmable. In the embodiment illustrated in FIG. 2, the high priority trace elements are typically those concerning instruction trace, for example trace signals relating to branch addresses, whilst the low priority trace elements are typically those relating to data trace, such low priority trace elements being able to be lost without losing synchronisation. In the absence of any signals being received by the trace generation logic 120 from the FIFO 130, the trace generation logic will be arranged to output appropriate trace data to the FIFO 130 dependent on the enable signals received from the trigger 110 over path 135. This might, for example, result in both instruction trace elements being issued over path 145 and data trace elements being issued over path 155. It will be appreciated by those skilled in the art that although two distinct paths have been illustrated in FIG. 2, both the instruction trace and the data trace signals would typically share connections between the trace generation logic 120 and the FIFO 130.

When tracing data in addition to tracing instructions, the data trace elements issued over path 155 can use the majority of the trace port bandwidth from the trace generation logic 120 to the FIFO 130. The trace elements are then drained through a narrow output trace port from the FIFO 130 to the trace buffer 12 via path 150. Typically, any trace elements issued over path 150 to the trace buffer 12 are also accompanied by trace valid signals over path 140 indicating whether the output trace is valid or not. A trace valid signal would typically be set to invalid if the associated trace module has no trace data to issue in that clock cycle.

The output bandwidth from the FIFO 130 is typically less than the input bandwidth and there is the potential for the FIFO 130 to overflow, for example in the event of a sustained burst of trace data being issued by the trace generation block 120. As an example, the input trace port can be 4-5 times wider than the output trace port to the trace buffer. By filtering, using the trace resources 110, the amount of trace data is reduced, thereby reducing the probability of an overflow occurring.

FIG. 3 illustrates in more detail the arrangement of the trace resources 110. As mentioned above, the trace resources 100 can be configured to perform any of a number of different trace activities, the execution of which can be controlled using trace instructions inserted into the program code to be analysed.

The trace resources 110 comprise trace activity logic 200 which is coupled to four hardware comparators 220 (only one of the four hardware comparators 220 is shown for clarity reasons) and a plurality of instrumentation resources 210 (again only one of the plurality of instrumentation resources 210 is shown for clarity reasons). The hardware comparators 220 are typically employed to determine whether a program instruction being executed by the processor core 6 falls within a predetermined range and, if so, to assert a signal on their output path. The instrumentation resources 210 are employed to be responsive to trace instructions encountered during the execution of the program instructions, and to assert or clear a signal provided on their output path in response to those trace instructions as will be explained in more detail below.

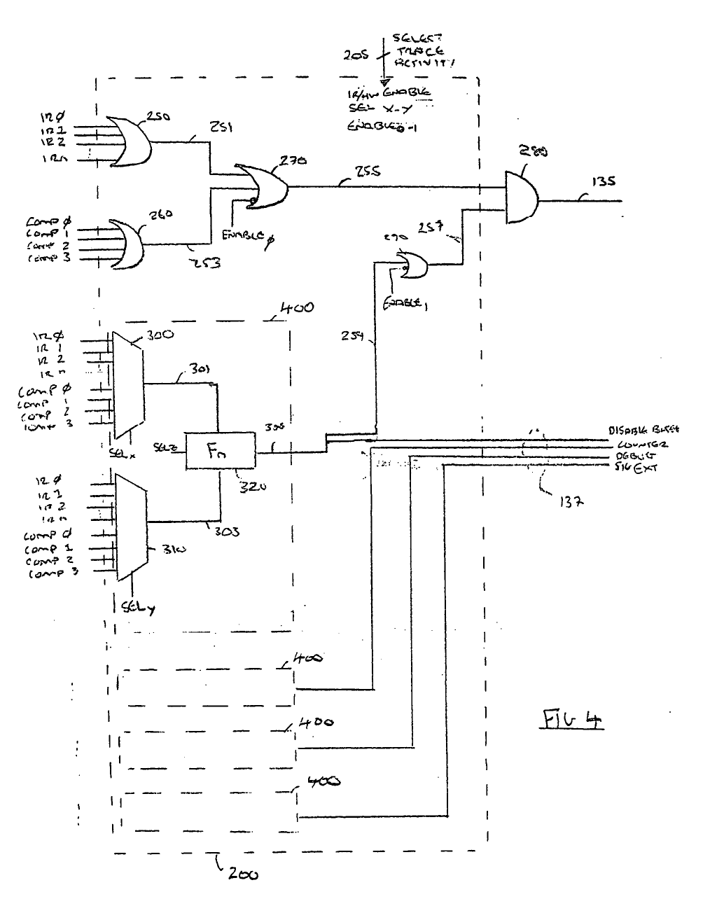

The trace activity logic 200 receives select trace activity signals over the bus 205 from the configuration registers 131 programmed by the general purpose computer 16. The select trace activity signals are used to configure the arrangement of the trace activity logic 200, thereby selecting the trace activities to be performed. The select trace activity signals are also used to select which hardware comparators and/or instrumentation resources are used to control the execution of those trace activities as will be explained in more detail with reference to FIG. 4.

Each hardware comparator 220 has a register 222 which is operable to store an upper address and a register 224 which is operable to store a lower address, the upper and lower addresses defining an address range. The hardware comparator also has a register 226 which is operable to store an indication of an access type of interest.

The sync logic 100 provides to the trace resources 110 an indication of the address associated with an instruction to be executed by processor core 6, together with an indication of the access type associated with that address. The indication of the address is provided over the path 221 to the hardware comparator and the indication of the access type associated with the address is provided over the path 223.

In the event that the access type stored in the register 226 matches the indication of the access type provided over the path 223 then a signal is asserted over the path 225 to a first input of an AND gate 228. If the indication of the address provided over the path 221 falls within the range defined by the registers 222 and 224, then signals are asserted over the paths 227 and 229 to respective inputs of the AND gate 228. When all the inputs of the AND gate 228 are asserted (indicating that the address of the instruction being executed by the processor core 6 falls within the predefined range and is of the type of interest) then the AND gate 228 will assert a signal over the path 231 to the AND gate 230.

In the event that the select trace activity signals provided over the bus 205 indicates that the trace activities selected within the trace activity logic 200 are to be responsive to signals generated by the hardware comparator, then an enable signal will be asserted over the path 233 to the other input of the AND gate 230. Accordingly, when the hardware comparator is enabled and a condition set within the hardware comparator occurs then a COMP 0 signal is asserted over the path 235 to the trace activity logic 200 which can then be used to control the execution of the selected trace activity.

For clarity reasons only one hardware comparator 220 is illustrated. However, it will be appreciated that the arrangement of the remaining hardware comparators would be identical. The contents of the registers within each hardware comparator 220 is programmed with signals provided from the configuration register 131.

The instrumentation resources 210 comprise a set-reset latch 212 an OR gate 214 and an AND gate 216. The state of the instrumentation resources 210 is responsive to trace instructions encountered during the execution of the program instructions. Typically, each instrumentation resource will be responsive to trace instructions have a particular predetermined instruction identifier. For example, instrumentation resource 0 may be responsive to trace instructions having an instruction identifier 0, instrumentation resource 1 may be responsive to trace instructions having an instruction identifier 1, and so on.

The operation of the instrumentation resources 210 will now be explained. The set-reset latch 212 is coupled to paths 211 and 213 which receive receives a set signal and a clear signal respectively. The set and clear signals are provided by the sync logic 100 in response to trace instructions embedded in the program instructions being executed by the processor core 6. For example, the occurrence of a trace set instruction which has the instruction identifier of 0 will result in a signal being provided by the sync logic 100 to instrumentation resource 0 over the path 211. Similarly, a trace clear instruction having an instruction identifier 0 will result in a signal being provided via the sync logic 100 to instrumentation resource 0 over the path 213. The set reset latch 212 responds to the signals provided over the paths 211 and 213 respectively and outputs a signal over the path 215 to a first input of an OR gate 214.

The other input of the OR gate 214 receives a toggle signal over the path 217 from the sync logic 100. The toggle signal is generated in response to a trace toggle instruction occurring in the program code being executed by the processor core 6. For example, the occurrence of a trace toggle instruction having an instruction identifier 0 will result in a toggle signal being provided via the sync logic 100 over the path 217 to the OR gate 214. As mentioned above, the occurrence of the toggle instruction can cause the toggle signal provided over the path 217 to be asserted for any of a predetermined number of processing cycles. For example, the toggle signal may be asserted for one or more processing cycles. Thereafter, the toggle signal is cleared. Hence, in the event that the set-reset latch 212 is set or a toggle signal has been provided, then the OR gate 214 will assert a signal to a first input of the AND gate 216.

In the event that the select trace activity signals provided over the bus 205 indicates that the trace activities selected within the trace activity logic 200 are to be responsive to signals generated by instrumentation resource 0, then an enable signal will be asserted over the path 219 to the other input of the AND gate 216. Accordingly, when the instrumentation resource is enabled, and either the instrumentation resource is responding to a trace set instruction or a trace toggle instruction, then a IR0 signal is asserted over the path 203 to the trace activity logic 200 which can then be used to control the execution of the selected trace activity.

For clarity reasons only one instrumentation resource 210 is illustrated. However, it will be appreciated that the arrangement of the remaining instrumentation resource would be identical. Also, it will be appreciated that the hardware resources required for each instrumentation resource is an order of magnitude less than each hardware comparator. Accordingly, for any given predetermined amount of hardware resource, many more instrumentation resources can be provided in comparison to hardware comparators.

As will be explained in more detail with reference to FIG. 4 below, the trace activity logic 200 receives signals from the instrumentation resources and the hardware comparators which control the execution of trace activities selected within the trace activity logic 200. The trace activity logic 200 can respond by asserting an enable signal over the path 135 to the trace generation logic 120 to turn the trace on or off, and, alternatively, or additionally, a trigger signal over the bus 137 to cause predetermined actions to occur.

FIG. 4 illustrates the arrangement of the trace activity logic 200 in more detail. The trace activity logic 200 receives the select trace activity signals over the bus 205. The configuration registers 131 are set to provide a number of enable and select signals in order to select the trace activities to be performed by the trace activity logic 200 The signals Enable₀, Enable₁, and Sel_{X-Z} are used to configure the arrangement of the trace activity logic 200 and to select the tracing activities to be performed. The IR/HW Enable signals are provided to the appropriate instrumentation resources and hardware comparators in order to select which of these resources or comparators are arranged to control the execution of the selected tracing activities.

In overview, the path 135 can provide a signal to the trace generator 120 to start/stop tracing. The assertion of the signal over the path 135 can be controlled by the inputs provided to the group of OR gates 250, 260 and 270 and by the inputs provided to the logic composed of multiplexers 300, 310, function logic 320, trigger routing logic 330 and OR gate 290. Also, the trigger signals provided over the bus 137 can be controlled by the inputs provided to the logic composed of multiplexers 300, 310, function logic 320, trigger routing logic 330 and OR gate 290.

The OR gates 270 and 290 receive an Enable₀ and Enable₁ signal respectively. The Enable₀ and Enable₁ signals when asserted cause the output of the respective OR gate to be dependent solely on its input signals.

The OR gate 250 receives the signals IR0 to IRn from the respective instrumentation resources 210. The OR gate 260 receives the signals COMP0 to COMP3 from the respective hardware comparators 220. Should any of the IR0 to IRn signals be asserted then a signal is asserted over the path 251 to one input of an OR gate 270. Should any of the signals provided to the OR gate 260 be asserted then a signal is asserted over the path 253 to another input of a OR gate 270. In the event that either of the signals provided to the OR gate 270 are asserted then a signal is asserted over the path 255 to one input of the AND gate 280. In the event that either the Enable₁ signal is deasserted or the signal provided over the path 259 is asserted then a signal is asserted over the path 257 to the other input of the AND gate 280. Should a signal be asserted over the path 255 to the AND gate 280 and the signal provided over the path 257 is also asserted then an enable signal is provided over the path 135 to the trace generation logic 120.

As mentioned above, asserting the signal Enable₀ on the inverting input of the OR gate 270 causes OR gate 270 to be responsive to signals provided on its other two inputs. Similarly, asserting the Enable₁ signal on the inverting input of the OR gate 290 causes OR gate 290 to be responsive to signals provided on its other input 259. Should the Enable₀ signal be deasserted then the operation of the group of OR gates 250, 260, 270 is effectively deactivated since irrespective of the inputs to these OR gates a signal will always be asserted over the path 255 to the AND gate 280. Similarly, in the event that the Enable₁ signal is deasserted then the operation of the multiplexers 300, 310, the function logic 320 and the trigger routing logic 330 is deactivated since irrespective of the inputs to this logic the OR gate 290 will always assert a signal over the path 257 to the AND gate 280.

Also provided within the trace activity logic 200 are two multiplexers 300 and 310, each of which receive the signals IR0 to IRn and Comp0 to Comp3. The configuration register 131 provides a SEL_{X} signal to the multiplexer 300 which selects one of its inputs and provides the value of that input over the path 301 to the function logic 320. Similarly, the multiplexer 310 receives from the configuration register 131 a SEL_{Y} signal which selects one of its inputs to be provided over its output 303 to the function logic 320.

The function logic 320 receives the two inputs provided over the paths 301 and 303 in addition to a SEL_{Z} signal from the activity decoder 240. The function logic 320 in response to the SEL_{Z} signal selects a predetermined arithmetic or logical function to be applied to input signals. For example, the function logic 320 may logically AND together the two input signals or one or more inverted versions thereof or may logically OR together the two input signals or one or more inverted representations thereof. The output of the function logic 320 is provided over the path 305.

Hence, it will be appreciated that the trace resources 110 have trace activity logic 200 which is configurable using signals provided over the bus 205 to select particular trace activities. The signals provided over the bus 205 also configure the instrumentation resources or hardware comparators which are used to control the execution of the trace activities selected within the trace activity logic 200. The configuration register 131 is programmed by the general purpose computer 16 in order to select the trace activities and the resources or comparators which control the execution of those activities. When the trace activity logic 200 is configured to generate trace data, the Enable₀ signal is asserted and the Enable₁ signal is deasserted. Hence, whenever any of the hardware comparators output a signal or a trace instruction is received which causes an instrumentation resource to output a signal then trace is enabled. Should all the hardware comparators cease to output a signal and all the instrumentation resources cease to output a signal then data trace can be terminated. This can be achieved by either clearing the set-reset latches within the instruction resources in response to a trace clear instruction or through the toggle signal being deasserted. Similarly, in the event that the trace activity logic 200 is to be configured to perform triggering events then the Enable₁ signal is asserted whilst the Enable₀ signal is deasserted. Accordingly, whenever the output of the function logic 320 is asserted the trigger routing logic 330 can cause a signal to be provided over the path 135 to cause trace data to be generated and a signal provided over the bus 137 to cause predetermined actions to occur.

Whilst, for clarity reasons, one logic group 400 comprising the multiplexers 300 and 310 and the function logic 320 is shown, more than one such group is provided, each of which enable a signal to be asserted over the bus 137 to cause one of any number of different predetermined actions to occur.

FIG. 5 illustrates schematically the flow of a piece of software code into which trace instructions have been inserted. The program is executed and, at point A, a call to Procedure 0 is made.

Inserted into Procedure 0 is a trace toggle instruction having an instruction identifier 0. At the end of Procedure 0 is a trace toggle instruction having an instruction identifier 1. Upon completion of Procedure 0 execution returns to point B and continues to point C where a call to Procedure 1 is made.

Inserted into Procedure 1 is a trace toggle instruction having an instruction identifier 0. At the end of Procedure 1 is a trace toggle instruction having an instruction identifier 1. Upon completion of Procedure 1 execution returns to point D and continues until point B where a call to Procedure 2 is made.

Inserted into Procedure 2 is a trace toggle instruction having an instruction identifier 0. Execution of procedure 2 continues until point F whereupon a call to Procedure 0 is made.

As mentioned previously, Procedure 0 has inserted thereto a trace toggle instruction having an instruction identifier 0. At the end of Procedure 0 there is provided a trace toggle instruction having an instruction identifier 1. Upon completion of Procedure 0 execution returns to point G whereupon the remaining portion of Procedure 2 is executed. At the end of Procedure 2 there is a trace toggle instruction having an instruction identifier 1. Upon completion of procedure 2 execution returns to point H and the software code continues to be executed until it reaches the end of the code.

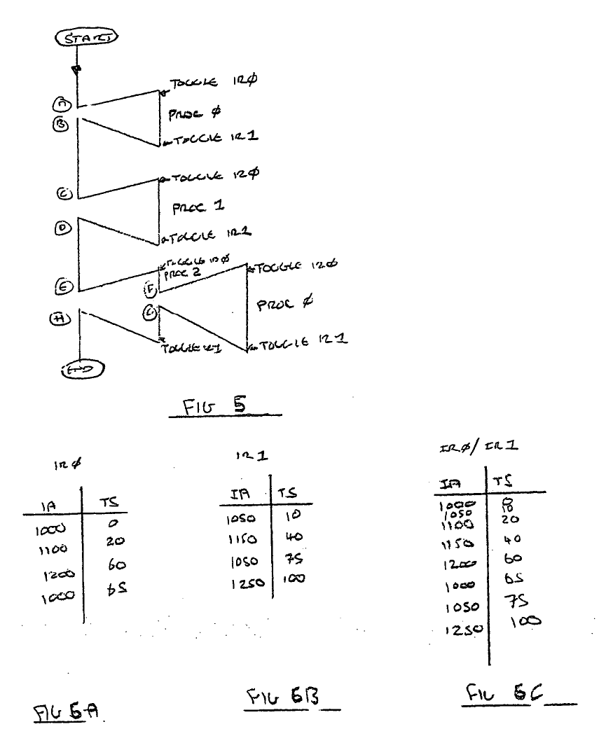

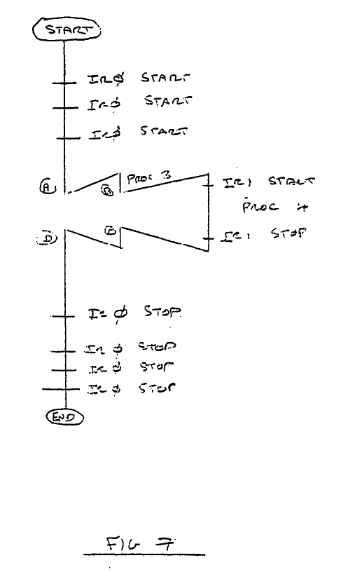

Hence, it will be appreciated that the software under test has various trace instruction inserted therein. The trace resources 110 can be configured to be responsive to those trace instructions in order to control the execution of selected trace activities, as will be illustrated in more detail with reference to FIG. 6A to 6C.

Although, FIG. 5 only illustrates the use of trace toggle instructions it will be appreciated that the software code could also be interspersed with trace set or trace clear instructions, as required. Also, it will be appreciated that other instruction identifiers could have been used, or that all the trace instructions have the same instruction identifier.

FIG. 6A to 6C illustrates how the software code described with reference to FIG. 5 can generate different trace data dependent on the trace activities selected to be performed by the trace resources 110.

In FIG. 6A, the trace resources 110 are configured to perform the generation of trace data in response to trace instructions having an instruction identifier 0 by supplying appropriate signals over the bus 205 to the activity decoder 240. Accordingly, the activity decoder 240 causes the Enable₁ signal to be deasserted and the Enable₀ signal to be asserted. Similarly, the activity decoder 240 will deassert all of the enable signals provided to the hardware comparators and will deassert all of the enable signals provided to the instrumentational resources 210 other than instrumentational resource associated with instruction identifier 0.

When the trace toggle instruction having an instruction identifier 0 is encountered, a toggle signal is asserted over path 217 to the OR gate 214 which in turn asserts a signal over path 201 to the AND gate 216, thereby asserted a signal over the path 203 to the trace activity logic 200. The OR gate 250 receives the signal and asserts a signal over the path 251 to the OR gate 270 which in turn outputs a signal over the path 255 to the AND gate 280. Accordingly, an enable signal is sent over the path 135 to the trace generator 120 to activate trace. The trace generator will then output trace data in the form of instruction address having the value 0x1000 (which corresponds to the instruction address of the instruction being executed by the core 6), together with a time stamp having the value of 0 (which indicates a relative clock cycle timing). In the next processing cycle the toggle signal provided over the path 217 is deasserted which causes the signal provided over the path 135 to the trace generator 120 to be deasserted, thereby preventing further trace data from being generated. Accordingly, a single item of trace data is generated in response to the trace toggle instruction.

On the occurrence of the trace toggle instruction having an instruction identifier of 1 the trace resources 110 will not cause any trace data to be generated since the execution of trace activity selected to be performed by the trace activity logic 200 can not be controlled by the instrumentation resources associated with the instruction identifier 1. However, on the occurrence of the trace toggle instructions having the instruction identifier of 0 which occur after points C, E and F, further trace data is generated for those cycles as illustrated in FIG. 6A.

FIG. 6B shows the trace data generated under a different configuration where the execution of trace activity selected to be performed by the trace activity logic 200 can be controlled by the instrumentation resources associated with the instruction identifier 1. As shown in FIG. 6B, this results in four items of trace data being generated on the occurrence of the trace toggle instructions having the instruction identifier 1, just prior to points B, D, G and H respectively.

FIG. 6C shows the trace data generated under a different configuration where the execution of trace activity selected to be performed by the trace activity logic 200 can be controlled by the instrumentation resources associated with the instruction identifiers 0 and 1. This results in eight items of trace data being generated, which corresponds to all the trace data illustrated in FIGS. 6A and 6B.

Hence, it can be seen that the selected trace activity can generate trace data each time a procedure is called, as illustrated in FIG. 6A. Also, the selected trace activity can generate trace data at the end of each procedure, as illustrated in FIG. 6B. Furthermore, the selected trace activity can generate trace data at the beginning and end of each procedure called as illustrated in FIG. 6C.

Whilst FIG. 5 shows trace instructions inserted at the beginning and end of each procedure, it will be appreciated that the software code to be analysed can have trace instructions inserted in any number of places in order to enable a wide range of trace activities and trace data to be performed.

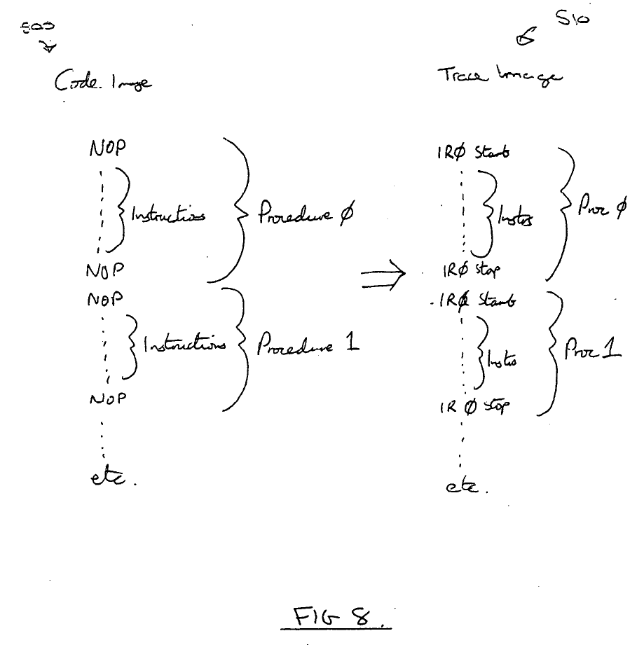

FIG. 7 shows an alternative arrangement of trace instructions inserted into program code to be analysed.

The program is executed and, at point A, a call to Procedure 3 is made. At point B a call to Procedure 4 is made. Upon completion of Procedure 4 execution returns to Procedure 3 at point C. Upon completion of Procedure 3 execution returns to point D.

Prior to point A, a number of trace set instructions having an instruction identifier 0 are provided. Following point D, a number of trace clear instructions having an instruction identifier 0 are provided. More than one trace set and more than one trace clear instructions are provided to take account of the possibility that entry and exit from different procedures may occur at different points. Providing trace set and trace clear instructions at different positions within the program code increases the likelihood that at least one of those trace instructions will be encountered.

Inserted near the beginning of Procedure 4 is a trace set instruction having an instruction identifier 1. Near the end of Procedure 4 is a trace clear instruction having an instruction identifier 1.

Hence, it will be appreciated that the software under test has various trace instructions inserted therein. The trace resources 110 can be configured to be responsive to those trace instructions in order to control the execution of selected trace activities.

The trace resources 110 may be configured to perform the generation of trace data in response to trace instructions having an instruction identifier 0 by supplying appropriate signals over the bus 205 to the activity decoder 240.

When one of the trace set instructions having an instruction identifier 0 is encountered, a set signal is asserted over path 215 to the OR gate 214 which in turn asserts a signal over path 201 to the AND gate 216, thereby asserted a signal over the path 203 to the trace activity logic 200. The OR gate 250 receives the signal and asserts a signal over the path 251 to the OR gate 270 which in turn outputs a signal over the path 255 to the AND gate 280. Accordingly, an enable signal is sent over the path 135 to the trace generator 120 to activate trace. The trace generator will then output trace data in the form of instruction address (which corresponds to the instruction address of the instruction being executed by the core 6), together with a time stamp (which indicates a relative clock cycle timing). In each of the following processing cycles the trace generator 120 will output trace data in the form of instruction address, together with a time stamp.

On the occurrence of the trace set instruction having an instruction identifier of 1 the trace resources 110 will not cause any trace data to be generated since the execution of trace activity selected to be performed by the trace activity logic 200 can not be controlled by the instrumentation resources associated with the instruction identifier 1. However, on the occurrence of any of the trace clear instructions having the instruction identifier of 0, a clear signal is asserted over path 213 to the OR gate 214 which in turn clears a signal over path 201 to the AND gate 216, thereby clearing a signal over the path 203 to the trace activity logic 200. The OR gate 250 receives the signal and clears a signal over the path 251 to the OR gate 270 which in turn clears a signal over the path 255 to the AND gate 280. Accordingly, an enable signal is cleared over the path 135 to the trace generator 120 to disable trace. The trace resources 110 may also be configured to perform the generation of trace data in response to trace instructions having an instruction identifier 1 by supplying appropriate signals over the bus 205 to the activity decoder 240. Thereafter, trace data is generated on the occurrence of the trace set instruction having an instruction identifier 0 and trace data ceases to be generated on the occurrence of the trace clear instruction having an instruction identifier 0.

Hence, it can be seen that the on-chip trace module 10 can perform a number of different tracing activities. Trace instructions are provided in the program instructions of the software code to be analysed. When the trace instructions are encountered they can control the execution of the selected tracing activity. By controlling the execution of the tracing activity using trace instructions rather than by using trigger logic, the number of conditions under which trace data is generated can be greatly increased. Hence, instead of being limited to typically only a limited number of sets of conditions which are programmed into trigger logic, trace data can be generated for a greatly increased set of conditions, only limited by the number of trace instructions inserted into the software code. Also, because each tracing instruction controls a number of tracing activities the number of different tracing instructions required to be provided can be limited, for example to just three trace instructions. It will be appreciated that the effect of any particular trace instruction will vary depending on the configuration of the tracing circuit and the tracing activity which has been selected. Accordingly, the same trace instruction can have a different effect depending on the arrangement of the trace circuit. Such an arrangement enables a wide range of tracing activities to be performed and a variety of trace data to be generated whilst still being controlled by a small number of trace instructions. Accordingly, trace data can be generated under a wide range of conditions which provides for a significant degree of flexibility without the need for trigger logic incorporating a proportionate number of registers and associated comparators.

FIG. 8 illustrates schematically the recompiling of a software code image to incorporate trace instructions.

A software code image 500 is provided. The software code image 500 comprises sequences of instructions, grouped into associated procedures. The software code image 500 includes a number of NOP (null operation) instructions incorporated therein. These instructions may be deliberately incorporated into the software code image 500, or may simply occur during the normal compilation process, or may be a combination of the two. During the recompilation process, trace instruction may be substituted for one or more of these NOP instructions, as required. As mentioned previously, the trace instructions have the effect of a NOP instruction. Hence, the trace instruction or the NOP instruction may remain in any eventual software code image and will cause no functional effect on the operation of that code. Also, the particular combination of trace instructions or NOP instructions can be varied using the recompilation process without changing the characteristics of that code.

In this example, each procedure is initiated and terminated by a NOP (null operation) instruction. Whilst it is shown that each procedure is initiated and terminated by a NOP (null operation) instruction, it will be appreciated that these instructions need not necessarily be placed at the exact start and end of these procedures. Each procedure may also include one or more NOP instructions at particular points of interest in that procedure.

During the recompilation process, selected ones of the NOP instructions are substituted by predetermined trace instructions. In the example shown, each NOP instruction at the beginning of a procedure is substituted with a trace set instruction having an instruction identifier 0, with each NOP instruction at the end of a procedure being substituted with a trace clear instruction having an instruction identifier 0.

Also, it will be appreciated that whilst substituting a NOP instruction for a trace instruction is shown, the technique can also be applied to removing any number of trace instructions no longer required by substituting them for either an alternative trace instruction or a NOP instruction.

It will be appreciated that this provides a convenient technique for altering the tracing configuration of the software code, without affecting the overall operation of that code.

Although a particular embodiment of the invention has been described herein, it will be apparent that the invention is not limited thereto, and that many modifications and additions may be made within the scope of the invention. For example, various combinations of the features of the following dependent claims could be made with the features of the independent claims without departing from the scope of the present invention.

I claim:

1. An apparatus for processing data, said apparatus comprising:
a data processing circuit operable over a sequence of processing cycles to perform data processing operations in response to program instructions; and
a tracing circuit configurable to perform a selected one of a number of tracing activities in which corresponding trace data is generated indicative of operation of said data processing circuit in response to said program instructions, said tracing circuit being operable to be responsive to trace instructions inserted into said program instructions to control execution of said selected one of a number of tracing activities in order to generate said trace data, each trace instruction being operable to control execution of each of a number of said tracing activities.

2. The apparatus of claim 1, wherein said trace instructions include a trace set instruction operable to cause said tracing circuit to generate trace data by causing said selected one of a number of tracing activities to be initiated.

3. The apparatus of claim 1, wherein said trace instructions include a trace clear instruction operable to cause said tracing circuit to cease generating trace data by causing said selected one of a number of tracing activities to be terminated.

4. The apparatus of claim 1, wherein said trace instructions include a trace toggle instruction operable to cause said tracing circuit to generate trace data for a number of processing cycles by causing said selected one of a number of tracing activities to be initiated in a first processing cycle and then terminated in a subsequent processing cycle.

5. The apparatus of claim 4, wherein said trace toggle instruction is operable to cause said tracing circuit to generate trace data for a single processing cycle by causing said selected one of a number of tracing activities to be initiated in said first processing cycle and then terminated in an immediately following processing cycle.

6. The apparatus of claim 1, wherein each trace instruction has the effect on the operation of said data processing circuit of an architectural no-operation.

7. The apparatus of claim 1, wherein each trace instruction is executable in a single processing cycle.

8. The apparatus of claim 1, wherein said number of tracing activities include instruction tracing in which trace data comprising information representative of program instructions being processed by said data processing circuit is generated.

9. The apparatus of claim 1, wherein said number of tracing activities include data tracing in which trace data comprising information representative of data values being processed by said data processing circuit in response to said program instructions is generated.

10. The apparatus of claim 1, wherein said tracing circuit is further configurable to cause a triggering event in which a triggering signal is generated which causes a predetermined action to occur, said tracing circuit being further operable to be responsive to trace instructions inserted into said program instructions to control execution of said triggering event.

11. The apparatus of claim 10, further comprising a trace buffer operable to store trace data and wherein said predetermined action comprises signalling said trace-buffer to cease the storage of trace data after a predetermined period.

12. The apparatus of claim 10, wherein said predetermined action comprises changing a counter value to indicate the occurrence of said triggering event.

13. The apparatus of claim 10, wherein said predetermined action comprises entering a debug state to enable operation of said data processing circuit to be determined.

14. The apparatus of claim 10, wherein said predetermined action comprises passing a signal external to said tracing circuit to enable operation of said data processing circuit to be determined.

15. The apparatus of claim 1, wherein said tracing circuit is configurable to perform a selected one of a plurality of tracing activities and each tracing instruction is operable to control execution of each of said plurality of tracing activities.

16. The apparatus of claim 1, wherein each trace instruction comprises an instruction identifier, said tracing circuit is configurable to perform a plurality of tracing activities, and each trace instruction having the same identifier is operable to control execution of one of said plurality of tracing activities.

17. The apparatus of claim 1, wherein each trace instruction comprises an instruction identifier, said tracing circuit is configurable to perform a plurality of tracing activities, and each tracing activity is responsive to trace instructions having a predetermined instruction identifier.

18. A method of tracing data in a data processing circuit operable over a sequence of processing cycles to perform data processing operations in response to program instructions, said method comprising the steps of:
configuring a tracing circuit to perform a selected one of a number of tracing activities in which corresponding trace data is generated indicative of operation of said data processing circuit in response to said program instructions;
controlling execution of said selected one of a number of tracing activities using trace instructions inserted into said program instructions in order to generate said trace data, each trace instruction being operable to control execution of each of a number of said tracing activities.

19. A computer program product comprising a trace instruction operable when executed on a data processing apparatus to perform the step of:
controlling execution of a selected one of a number of tracing activities in order to generate trace data, said trace instruction being operable to control execution of each of a number of tracing activities.

20. A method of modifying compiled software to be executed by a processor core, said method comprising the steps of:
providing a compiled software code image having at least one predetermined first instruction inserted therein; and
generating a modified software code image by substituting at least one of said predetermined first instructions with a predetermined second instruction, wherein at least one of said predetermined first instruction and said predetermined second instruction comprises a trace instruction.

21. The method of claim 20, wherein each of said predetermined first instruction and said predetermined second instruction causes no operation to be performed by said processor core when executed.

22. The method of claim 20, wherein said step of providing comprises providing a software code image having at least one null operation instruction inserted therein and said step of generating comprises generating a recompiled software code image by substituting at least one of said null operation instructions with a trace instruction.

23. The method of claim 20, wherein said step of providing comprises providing a software code image having at least one trace instruction inserted therein and said step of generating comprises generating a recompiled software code image by substituting at least one of said trace instructions with a different trace instruction.

24. The method of claim 20, wherein said step of providing comprises providing a software code image having at least one trace instruction inserted therein and said step of generating comprises generating a recompiled software code image by substituting at least one of said trace instructions with a null operation instruction.
